(19) United States
(12) Patent Application Publication
(10) Pub. No.: US 2012/0076305 A1
(43) Pub. Date: Mar. 29, 2012

(54) Spatial Audio Mixing Arrangement

(75) Inventor: Jussi Virolainen, Espoo (FI)

(73) Assignee: NOKIA CORPORATION, Espoo (FI)

(21) Appl. No.: 13/322,857

(22) PCT Filed: May 27, 2009
(86) PCT No.: PCT/FI2009/050441

§ 371 Date: Nov. 28, 2011

(51) Int. Cl. H04R 5/00

(52) U.S. Cl. 381/17

(57) ABSTRACT

A method comprising: receiving a plurality of audio input signals in a mixer apparatus; selecting a predetermined number of active audio input signals to be used as the basis for room effect signal generation; applying the predetermined number of dedicated room effect processing units based at least partly on the selected predetermined number of audio input signals; creating a set of spatialized signals for a plurality of audio output signals; and creating the plurality of audio output signals by combining, for each output signal m, spatialized signals created for the output signal m and room effect signals from all room effect processing units.

### FIELD OF THE INVENTION

The present invention relates to mixing of audio signals for spatial audio representation, for example for teleconferencing systems making use of spatial audio, gaming, virtual reality systems, etc.

### BACKGROUND OF THE INVENTION

Many multi-party audio applications typically host more than two participants. Examples of such applications include teleconferencing, virtual reality systems, audio communication between players in a gaming environment, etc. For example, traditional teleconference systems employ monophonic audio, which is likely to result in intelligibility and speaker recognition problems in conferences with large number of participants. The problems are especially pronounced in quite common case when more than one of the conference participants is talking at the same time; according to practical experience such a double-talk phenomenon has been observed to take place up 10% of the duration of a conference session. Similar considerations apply also to other multi-party audio applications.

Therefore, for intelligibility reasons it may be beneficial to make use of spatial audio technology in order to render the sound from separate audio sources in different directions in an auditory space (as perceived by a listener). That is, the user experience is improved when multiple sound sources are placed in different locations in a spatial (3D) audio space.

A spatial audio image may be considered to comprise direct (or directional) sound components representing the actual sound sources and an ambient component representing the spatial effect the acoustic space, i.e. “the room effect”. Typically a spatial audio image is represented by using two or more audio channels. A desired perceived arrival direction of a sound can be created by introducing similar signal in a number of audio channels, for example in left and right channels, exhibiting suitable differences in amplitude and phase, whereas a desired room effect may be created by introducing suitable correlations between the channels of the audio signal. Spatial processing may also comprise head related transfer function (HRTF) filtering for direct sound and artificial room effect processing. In HRTF filtering the input signal is processed with a pair of HRTF filters to produce two-channel binaural output. As a result of spatial representation, speech intelligibility and speaker detection especially during simultaneous speech are improved and there is also the possibility to create a more natural sounding virtual audio environment including also the room effect.

For example a centralized teleconferencing system comprises at least one single conference bridge (a.k.a. conference server) and a number of user terminals. From the conferencing system point of view, the conference bridge is responsible for receiving audio streams from user terminals, possible further processing of audio input signals (e.g. automatic gain control, active stream detection, mixing, and spatialization) and directing audio output signals to the user terminals. The user terminals are responsible for audio capture and reproduction.

In a basic approach for implementing a spatial audio (a.k.a. 3D audio) processing and mixing, for example for a teleconferencing system, as shown in FIG. 1, spatial processing is applied to the audio input signals (in a teleconference example, to signals received from conference participants, possibly excluding participant's own input signal) separately and the resulting multi-channel signals, such as binaural signals are mixed together. Parallel to the spatial processing, audio input signals are downmixed for room effect processing. Room effect outputs are mixed with the spatially processed input signals. Resulting mixed signal is then provided as an output signal (for transmission to a specific participant in the teleconference example). Similar kind of processing may need to be repeated for a number output signals (for a number of participant of a teleconference), whereas the positions and composition of sound sources within the auditory image may be unique for each output signal (e.g. different locations for each listener in a teleconference, and participant's own voice typically also excluded from the respective output signal).

The centralized teleconferencing example can be generalized to any audio system receiving at least one audio input signal, applying spatial audio processing to input signal(s), and providing at least one audio output signal, i.e. for example to virtual reality systems or gaming environments making use of spatial audio, etc.

However, this basic approach has some disadvantages. One of the challenges in multi-party audio processing systems employing spatial audio as described above is the computational load resulting from the spatial processing. Furthermore, the computational load and memory consumption are likely to increase significantly as a function of number of output signals due to dedicated processing applied for a number of output signals typically required for example in the teleconference use case. Since in many such applications, for example in spatial audio conferencing applications running over a mobile network, it is important both to keep the computational load and memory consumption at reasonable level and to be able to predict and possibly also control the usage of computation and memory resources.

The general problem of the computational load involved in the spatial processing is also recognized by US 2008/0144794, which discusses several approaches related to (virtual) spatialization process. Especially paragraphs [0089] to [0093] describing an embodiment, where a single-server spatialization providing a shared viewpoint for all users is carried out, addresses the complexity issue by proposing a simplified framework in order to reduce the computational load involved in the spatialization processing. In US 2008/0144794, output signal for each participant is spatialized with a single spatializer, which simply sums up the output signals from other participants. However, the proposed solution encounters the same challenges of increased computational load and memory consumption, when the number of the participants is high.

Therefore, novel solutions facilitating optimization of the computational load required for spatial processing would improve feasibility of systems making use of spatial audio processing.

### SUMMARY OF THE INVENTION

Now there has been invented an improved method and technical equipment implementing the method, by which computational load and memory consumption can be significantly decreased in many multi-party audio processing situations. Various aspects of the invention include a method, an apparatus and a computer program, which are characterized by what is stated in the independent claims. Various embodiments of the invention are disclosed in the dependent claims.

According to a first aspect, a method according to the invention is based on the idea of receiving a plurality of audio input signals in a mixer apparatus; selecting a predetermined number of active audio input signals to be used as a basis for room effect signal generation; applying the predetermined number of dedicated room effect processing units based at least partly on the selected predetermined number of audio input signals; creating a set of spatialized signals for a plurality of audio output signals; and creating the plurality of audio output signals by combining, for each output signal m, spatialized signals created for the output signal m and room effect signals from all room effect processing units.

According to an embodiment, said creating the plurality of audio output signals further comprises excluding the room effect signals determined based at least partly on at least one input signal corresponding to the output m.

According to an embodiment, the method further comprises: in response to the spatialized signals created for the output signal m including a spatialized signal created for at least one input signal corresponding to the output signal m, excluding the spatialized signal created for the at least one input signal corresponding to the output signal m.

According to an embodiment, the method further comprises: creating, for each of the plurality of audio output signals, a set of spatialized signals for the output signal m by applying dedicated spatial processing to a set of audio input signals, wherein the set of audio input signals comprises all of the plurality of audio input signals.

According to an embodiment, the method further comprises: creating, for each of the plurality of audio output signals, a set of spatialized signals for the output signal m by applying dedicated spatial processing to a set of audio input signals, wherein the set of audio input signals comprises a subset of the plurality of audio input signals, said subset including the selected predetermined number of active audio input signals.

According to an embodiment, the method further comprises: creating, for each of the plurality of audio output signals, a set of spatialized signals to be shared by all audio output signals by applying common spatial processing to a set of audio input signals.

According to an embodiment, the predetermined number of the active audio input signals to be selected is set as two.

According to an embodiment, said dedicated room effect processing units are arranged to apply room effect processing to the selected predetermined number of audio input signals.

According to an embodiment, the method further comprises: detecting the active audio input signals by voice activity detection means included in the conference call apparatus.

The arrangement according to the invention provides significant advantages. The embodiments allow significant savings both in terms of processing load and memory usage for audio spatialization process involving several audio inputs. Furthermore, the increasing number of audio inputs results in only a marginal increase in the processing load and memory consumption. Moreover, the embodiments enable predicting the usage of computation and memory resources, and also controlling the usage to a desired level.

According to a second aspect, there is provided an apparatus for mixing audio signals for spatial audio representation, the apparatus comprising: a plurality of inputs for receiving a plurality of audio input signals in the apparatus; a control unit for selecting a predetermined number of active audio input signals to be used as the basis for room effect signal generation; a plurality of dedicated room effect processing units, from which the predetermined number of dedicated room effect processing units are arranged to be applied on the selected predetermined number of audio input signals; a plurality of spatial processing units for creating a set of spatialized signals for a plurality of audio output signals; and one or more combining units for creating the plurality of audio output signals by combining, for each output signal m, spatialized signals created for the output signal m and room effect signals from all room effect processing units.

These and other aspects of the invention and the embodiments related thereto will become apparent in view of the detailed disclosure of the embodiments further below.

### LIST OF DRAWINGS

In the following, various embodiments of the invention will be described in more detail with reference to the appended drawings, in which

FIG. 1 shows an approach for implementing a spatial mixing arrangement;

FIG. 2 shows an example of implementation for a spatial mixing arrangement;

FIG. 3 shows an implementation of a spatial mixing arrangement according to a first embodiment of the invention in a reduced block chart;

FIG. 4 shows an implementation of a spatial mixing arrangement according to a second embodiment of the invention in a reduced block chart;

FIG. 5 shows an implementation of a spatial mixing arrangement according to a third embodiment of the invention in a reduced block chart;

FIG. 6 illustrates the total computational load of different embodiments as a function of the number of participants; and

FIG. 7 illustrates the total memory consumption of different embodiments as a function of the number of participants.

### DESCRIPTION OF EMBODIMENTS

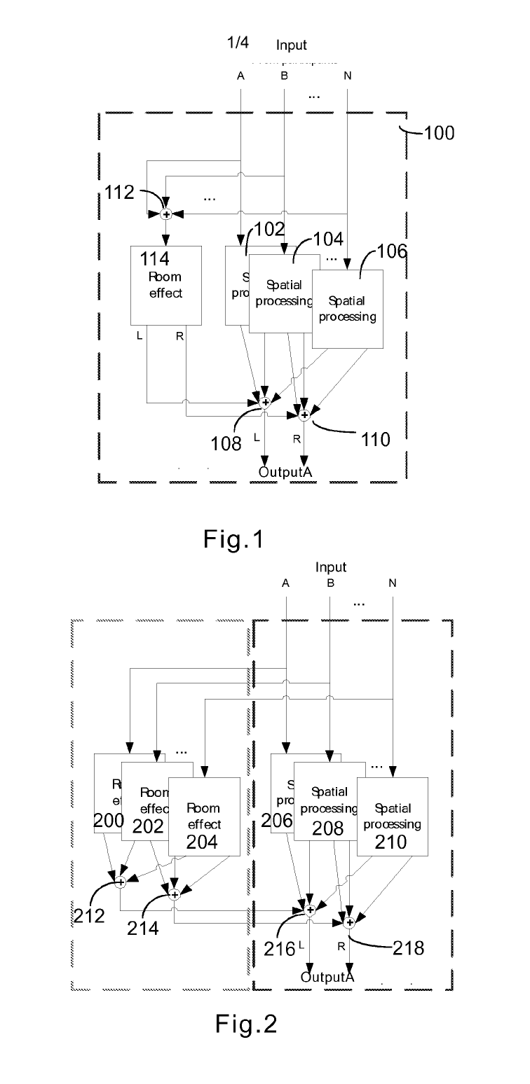

FIG. 1 shows an approach for implementing a spatial mixing arrangement 100, for example in a teleconferencing server. There is a plurality of audio input signals (A, B, . . . , N) received for example from participants of a teleconference. The audio input signals are typically encoded using an encoder of a transmitting codec known per se, and thus the audio signals are correspondingly decoded by a decoder of the receiving codec connected to respective input (not shown). However, encoding of audio signals (e.g. by terminals) and decoding (e.g. in the conference bridge) are not relevant to the invention.

The plurality of the input signals (A, B, . . . , N, possibly excluding listener's own signal) are spatially processed separately in spatial processing units 102, 104, 106 and the resulting binaural signals are mixed together in summing units 108 and 110. Parallel to the spatial processing, input signals are downmixed in a summing unit 112 for room effect processing. Outputs of the room effect unit 114 are mixed with the outputs of spatial processing units 102, 104, 106. Resulting signal is then provided as an output signal, for example for transmission to a participant of the teleconference. Similar kind of processing may be performed for a number of output signals, whereas the positions and composition of sound sources may be unique for each output signal (e.g. different locations for listener in a teleconference and participant's own voice typically also excluded from the respective output signal).

It can be easily seen that in such arrangement the computational load and memory consumption increase significantly when the number of output signals increases due to dedicated processing applied for the output signals. Furthermore, since all input signals are processed in similar manner, it may be considered as a waste of computational resources to process and mix sound sources that are not carrying meaningful information, for example sound sources that are currently silent.

FIG. 2 shows an alternative spatial mixing arrangement, which serves as a basis for the embodiments disclosed below. In a spatial mixer, operating for example on a teleconferencing server according to FIG. 2, there are individual room effect units 200, 202, 204 for each of the input signals, and the room effect units are conceptually located separately from the spatial processing units 206, 208, 210. Each input signal is processed by its own room effect (which may be a common room effect) and the left and right channel outputs of the room effect units are summed up in summing units 212, 214. The outputs of the summing units 212, 214 are then combined with the left and right channel spatialized input signals, correspondingly, in summing units 216, 218. The arrangements of FIG. 1 and FIG. 2 provide typically perceptually similar output, if the room effect parameters used in the room effect units 200, 202, 204 are the same. Even though the basic implementation of FIG. 2 provides the advantage that each input signal could be assigned an individual room effect (by adjusting the room effect parameters individually), it still suffers from the same major problem as the arrangement according to FIG. 1: the computational load and memory consumption increase significantly when the number of input and output signals increases.

The following embodiments are based on two main assumptions: 1) only signals that are considered to carry meaning full content are to be processed, and 2) resulting output signals share the same artificial room effect settings. The first assumption calls for identification of the signals that carry meaningful information, for example for voice activity detection (VAD) of input signals in order to distinguish active speech or audio from silence/plain background noise. Input signal activity can be used to define which input signals need to be processed and how to control the processing. The second assumption, while providing some limitations in the versatility of the spatial image, still nevertheless allows re-structuring of the room effect processing, which enables to achieve get considerable savings in the total computational load and in the memory consumption.

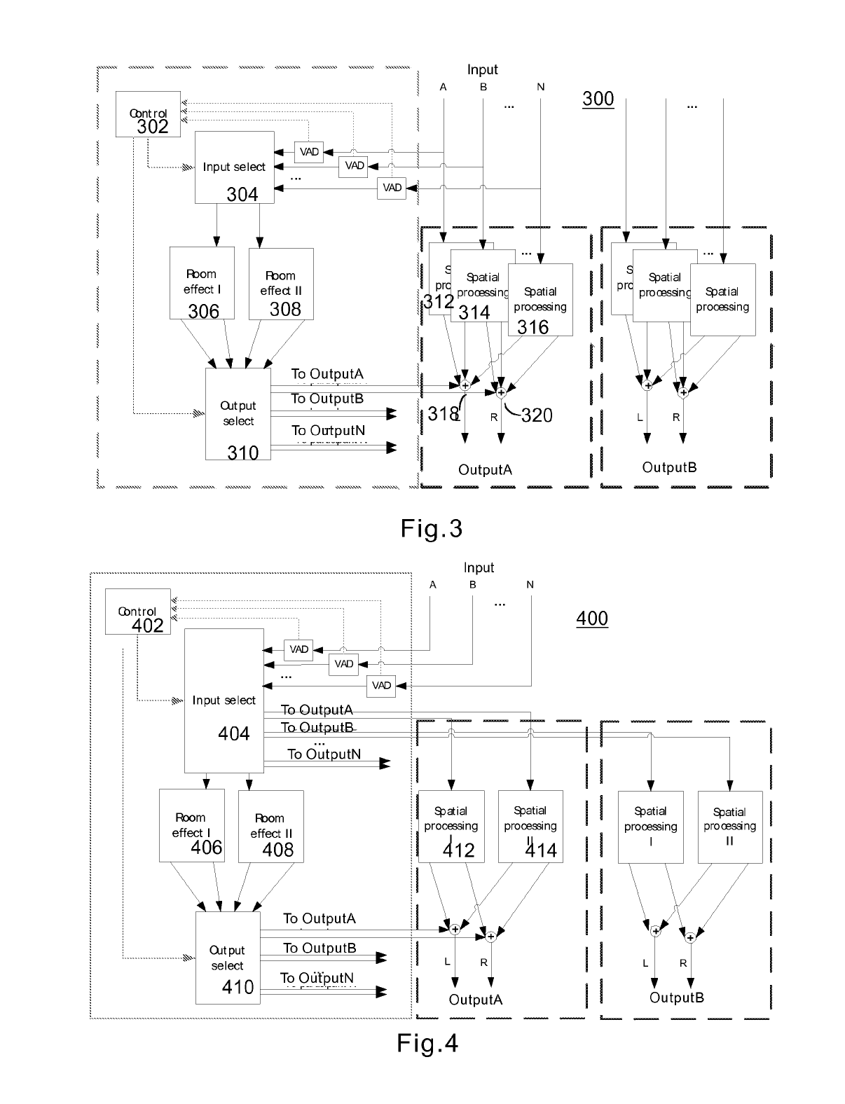

A first embodiment of the mixing arrangement, for example on a conference server (conference bridge) is disclosed in FIG. 3. A plurality of input signals (A, B, . . . , N) are provided as input to a mixer unit 300, which monitors the voice activity of input audio signals (input signals A, B, . . . , N). Input of the mixer unit 300 may comprise a number of VAD units (VAD₁, . . . , VADₙ, Voice Activity Detection), which are arranged to detect active speech in a received audio signal. Alternatively, one or more input signals may share a VAD unit. In such an arrangement a VAD unit may process several input signals in parallel or process one input signal at a time. In practice an audio signal arriving in the VAD unit is arranged in frames, each of which comprises N samples of audio signals. The VAD unit evaluates an input frame and, as a result of the evaluation, provides a control signal indicating whether or not active speech—or active signal content in general—was found in the frame to a control unit CTRL 302. Thus, control signals from VAD unit are supplied to the control unit CTRL, from which control signals the control unit CTRL can determine at least whether the frames of the incoming audio signals (A, B, . . . , N) comprise simultaneously active speech signals.

The control unit CTRL 302 is arranged to select a predefined maximum number K of simultaneously active input signals for processing. As an example, the predefined maximum number K may be two (K=2). The control unit CTRL 302 is thus arranged to control an input select unit 304 to feed the selected signals separately to room effect units 306 and 308. Therein, the room effect unit may comprise processing, for example, for ambience signal generation; i.e. a first selected signal is connected to the Room Effect Unit I and a second selected signal is connected to Room Effect Unit II.

In parallel to the room effect processing, a plurality of input signals (A, B, . . . , N) are spatially processed specifically for an output signal. Thus, there may be dedicated spatial processing unit for each output signal, or some of the output signals may share a spatial processing unit. In this spatial processing, a dedicated spatial processing is applied to the input signals in the plurality of spatialization units 312, 314, 316, comprising preferably one spatialization unit for each input signal. In an embodiment of the invention, in spatial processing, an input signal corresponding respective output signal may be excluded from the output signal, thus creating a plurality (N) of output signal specific spatialized signals, each being based on N−1 input signals. For example in a teleconference system using an embodiment of the invention, an input signal comprising a signal originating from a participant is typically excluded from the output signal provided for transmission for the same participant to avoid feeding back talker's voice back to him/her.

It is obvious to a skilled person that additional audio signal processing, such as possible Doppler effect, Occlusion, Obstruction, Distance effect and source directivity filtering may be applied before signal is provided to spatialization units. Alternatively, additional audio signal processing, as discussed above, may be applied as part of the spatialization unit processing.

Then, based on the control signal received from the control unit CTRL 302, an output select unit 310 is arranged to define, which room effect unit output signals (or combination of room effect unit output signals) are mixed with spatially processed signals to provide a respective output signal. For example, if from a group of a plurality of participants (A, B, C, . . . , N) of a teleconference, participant A and B are talking simultaneously, the input signal from A may be connected to the Room Effect Unit I and the input signal from B to the Room Effect Unit II. The output select unit 310 selects the room effect signal from the Room Effect Unit II to be mixed with respective spatially processed signals to provide an output signal for transmission for client A (A hears B) in summing units 318 and 320. In a similar manner, the room effect signal from the Room Effect Unit I is mixed with respective spatially processed signals to provide an output signal for client B (B hears A). The room effect signals from the both room effect outputs are mixed with respective spatialized signals to provide output signals for other clients (i.e. other participants C, . . . , N hear both A and B). The output of the summing units 318 and 320 may be supplied to an audio codec (not shown) used in the system where it is encoded into a signal to be provided for transmission. Room effect output levels from 306 and 308 can be controlled separately before they are mixed to different client outputs. This way room level can be set differently for each individual source and for each client. Summing units 318 and 320 can be replaced with mixer units if additional control of direct sound and room effect levels is needed.

It is generally known that the room effect processing easily increases the memory consumption, especially when the number of input signals increase. Thus, in the implementation according to the first embodiment, where the number of the signals selected for the room effect processing is limited to a predetermined number, preferably to two, the memory consumption is significantly reduced compared to the prior art solution, especially when the number of input signals is high.

A second embodiment of the mixing arrangement, for example on a conference server is disclosed in FIG. 4. The basic difference between the first and the second embodiment is that in the second embodiment, in addition to limiting the number of room effect units, also the number of spatialization units per output signal is limited to a predefined maximum number. The structure and the operation of mixer unit 400 is otherwise similar to that of the first embodiment, but the control unit CTRL 402 is arranged to control the input select unit 404 to provide the selected input signals, in addition to the room effect units 406 and 408, also to the predetermined number of spatialization units 412, 414.

Thus, the spatial processing part is also optimized by limiting the number of simultaneous spatially processed sources to a predetermined value, for example to two sources (K=2). The control unit CTRL 402 is arranged to control the input select unit 404 to provide the same selected, for example two, signals to the Room Effect Unit I and to the Room Effect Unit II, as well as to a first spatial processing unit I and to a second spatial processing unit II in output signal specific parts. Now, when a first input signal is active, the first signal is connected to the spatial processing unit that contributes to the output signal corresponding to the first input signal, wherein the first signal is preferably muted. Alternatively, the control unit CTRL 402 may be arranged to control the input select unit 404 to filter out the first input signal and may provide additional (third) input signal instead for the respective spatial processing unit. An output select unit 410 defines which room effect unit output signals (or combination of room effect unit output signals) are mixed with respective spatialized signals to provide an output signal.

For example, if from a group of a plurality of participants (A, B, C, . . . , N) of a teleconference, participants A and B are talking simultaneously, the input signal from the participant A may be connected to Room Effect Unit I and to all spatial processing I unit inputs in client specific parts. The input signal from the participant B is connected to Room Effect Unit II and to all spatial processing II unit inputs in client specific parts. The output select unit 410 selects the room effect signal from the Room Effect Unit II to be mixed with respective spatialized signals to provide an output signal for client A (A hears B). In a similar manner, the room effect signal from the Room Effect Unit I is mixed with respective spatialized signals to provide an output signal for client B (B hears A). The room effect signals from the both room effect outputs are mixed with respective spatialized signals to provide output signals for other clients (i.e. other participants C, . . . , N hear both A and B).

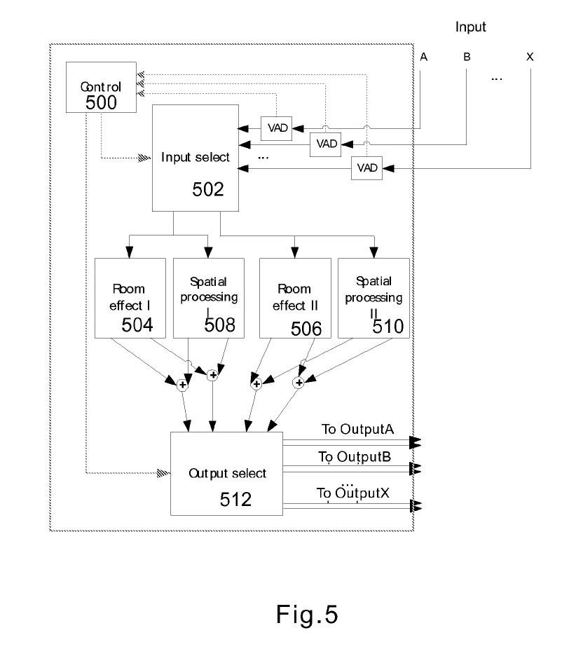

A third embodiment of the mixing arrangement, for example on a conference server, is disclosed in FIG. 5. The basic difference between the first and/or second and the third embodiment is that in the third embodiment separate output signal-specific spatial processing parts are not used anymore, but in addition to the room effect signal generation, also the spatial processing parts are common for all output signals. This allows limiting the total number of simultaneous spatially processed sources to a predetermined value, for example to two sources, which advantageously enables processing with substantially constant computational load.

Control unit generates control signals for Input select unit and Output select unit, for example according to monitored VAD values. Input select unit connects one input signal to Room Effect I and to spatial processing I, and another input signal to Room Effect II and to spatial processing II. Output select unit defines which room effect unit output signals (or combination of room effect unit output signals) are mixed with respective spatialized signals to generate an output signal. For example, if participant A and B of a teleconference are talking simultaneously, the input signal from A may be connected to Room effect I and to spatial processing I unit. The input signal from talker B is connected to Room effect II and to spatial processing II unit. The output select unit 410 selects the room effect signal from the Room Effect Unit II and from the spatial processing II to be mixed to provide an output signal for client A (A hears B). The room effect signal from the Room Effect Unit I and the spatialized signal from the spatial processing I unit are mixed to provide an output signal for client B (B hears A). Both room effect output signals are mixed to provide output signal(s) to other clients. (other clients hear both A and B).

In the third embodiment, the use of common spatial processing units means that an input signal will be spatialized to the same virtual position of the auditory image in each of the output signals. For example in a teleconference this could imply that in each listeners' viewpoint the talkers are spatialized in the same location of the auditory space. The spatialization may be carried out in such a way that, for example in a teleconference with participants A, B and C, all other participants hear the participant A always at left side, the participant B in the middle and the participant C at the right side. Since the participant as a listener preferably does not hear his/her own voice, there will be a gap in that particular spatial position; i.e. the participant A does not hear anybody at the left side, for example.

According to an embodiment, the VAD information may be determined locally at the mixer or a device hosting the mixer using a voice activity detector unit(s) operating on received audio signals. For example, the VAD units can be replaced by means which employ audio signal checking, known as ACD units (Audio Content Detector), which analyze the information included in an audio signal and detect the presence of the desired audio components, such as speech, music, background noise, etc. The output of the ACD unit can thus be used for controlling the control unit CTRL in the manner described above.

According to another embodiment, the VAD information associated with some or all of the input audio signals may be received from an external source, for example as part of or in parallel with the respective input audio signal. For example, the receiving audio component can be detected using the meta data or control information preferably attached to the audio signal. This information indicates the type of the audio components included in the signal, such as speech, music, background noise, etc.

According to a further embodiment, switching from one input to another includes cancellation of audible artefacts, which could be generated to the output signal from the input select unit. This can be implemented for example such that the control unit CTRL controls the input select unit to apply e.g. crossfade between a first input signal and a second input signal, when switching from the first to the second input signal. It is assumed that when input signal to any spatial processing unit is changed (e.g. from input A to input B) by input select unit, also corresponding spatial position may be provided to the respective spatial processing unit. This is not shown in the figures.

In various embodiments of the invention, in addition to audio input signals to the mixer, also other audio signals can be spatialized and mixed to the output signals. Such audio signals may be locally generated audio signals that may be generated for example by reading an audio signal or information that may be used to generate an audio signal from a file stored in memory. For example in a teleconference, examples of such signals are voice messages (e.g. “welcome to the conference”) or beeps or audio tones (when someone joins the session) generated by the conference server. In a gaming server such audio signals may be, for example, any other sound sources that are part of the virtual environment. Additional signals may be targeted to a specific output signal, to a subset of output signals or for all output signals.

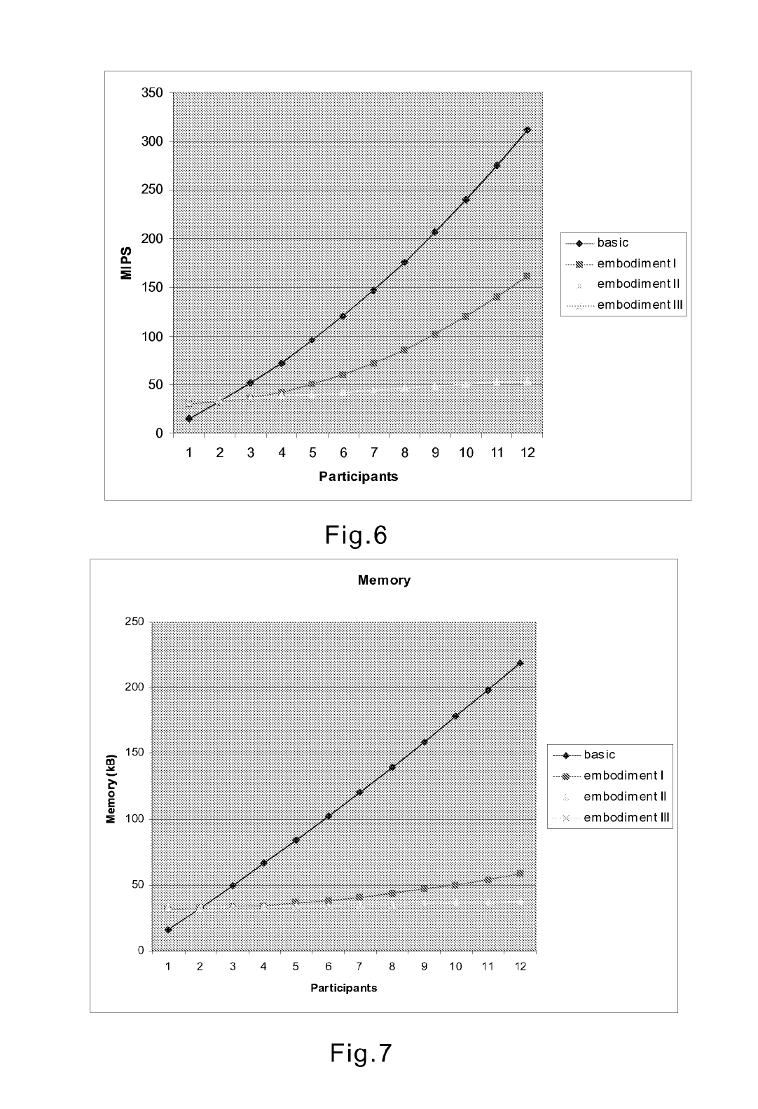

The advantages of the embodiments described above are convincingly demonstrated by Tables 1 and 2, and further by FIGS. 6 and 7 by applying respective embodiments of the invention in a teleconference system. In Table 1, an example of computation load (in terms of MIPS) of different embodiments compared to the basic implementation is given with the following assumptions: the number of participants (N) is 6, the number of simultaneous audio signal paths (K) is 2, the computational load of each spatialized source is 1 MIPS/source, and the computational load of each room effect unit is 15 MIPS/unit.

TABLE 1

| | | | Total MIPS |
|---|---|---|---|
| | | | N = 6, K = 2 |
| | | Room | ROOM = 15 |
| | Positional | effect | POSIT = 1 |
| Basic | N * (N-1) | N × ROOM | 6 * 5 * 1 + 6 * |
| | | | 15 = 120 MIPS |
| Embodiment I | N * (N-1) | 2 * ROOM | 6 * 5 * 1 + 2 * |
| | | | 15 = 60 MIPS |
| Embodiment II | K * N * | 2 * ROOM | 6 * 2 * 1 + 2 * |
| | POSIT | | 15 = 42 MIPS |
| Embodiment | 2 * POSIT | 2 * ROOM | 2 * 1 +2 * |
| III | | | 15 = 32 MIPS |

As can be seen from Table 1, with 6 teleconference participants the total computational load of different embodiments is approximately ¼ to ½ of that of the basic implementation.

FIG. 6 illustrates the total computational load of different embodiments as a function of the number of participants. It can clearly be seen that the basic implementation follows exponential growth. The first embodiment (I), wherein the room effect is optimized, is already beneficial when there are 3 or more participants in the session. In terms of the total computational load, the second embodiment (II) outperforms the first embodiment (I) when there are 5 or more participants in the session. When there are 10 or more participants in the session, the third embodiment (III) is superior to the other solutions while providing almost constant MIPS limit. Obviously, the third embodiment (III) is especially well-suited for mobile spatial audio conferencing servers expected to host conferences with large number of participants.

Table 2 illustrates the same example from the perspective of memory consumption of different embodiments compared to the basic implementation, including the further assumptions: the memory capacity needed for each spatialized source is 0.2 kB/source, and the memory capacity needed for each room effect unit is 16 kB/unit.

TABLE 2

| | | | Total Memory |
|---|---|---|---|
| | | | N = 6, K = 2 |
| | | Room | ROOM = 16 kB |
| | Positional | effect | POSIT = 0.2 kB |
| Basic | N * (N-1) | N × ROOM | 6 * 5 * 0.2 + 6 * |
| | | | 16 = 102 kB |
| Embodiment I | N * (N-1) | 2 * ROOM | 6 * 5 * 0.2 + 2 * |
| | | | 16 = 38 kB |
| Embodiment II | K * N * | 2 * ROOM | 6 * 2 * 0.2 + 2 * |
| | POSIT | | 16 = 34.4 kB |
| Embodiment | 2 * POSIT | 2 * ROOM | 2 * 0.2 + 2 * |
| III | | | 16 = 32.4 kB |

Table 2 shows that since the number of room effect units needed is the main factor effecting to the total memory consumption, the embodiments using only two room effect units are superior over the basic implementation when the number of participants increases. The same effect is manifested in FIG. 7, which illustrates the total memory consumption of different embodiments as a function of the number of participants. In the basic implementation, an increase in the number of participants results in a linear growth of required memory capacity. Thus, all the embodiments bring saving to the memory consumption, since only two common room effect units are needed for all participants. When compared to the first embodiment (I), the second embodiment (II) and the third embodiment (III) need slightly less memory, since the number of spatial processing units per listener is limited.

A skilled man appreciates that any of the embodiments described above may be implemented as a combination with one or more of the other embodiments, unless there is explicitly or implicitly stated that certain embodiments are only alternatives to each other. Thus, in accordance with an embodiment, it may be possible to switch between the basic implementation and any of the three embodiments discussed above for example in order to optimize the computational load and/or the total memory consumption. Such switching may take place also during the operation of a mixing process, for example during a teleconference session. As can be seen in FIG. 7, it could be beneficial in terms of memory consumption to use the basic implementation, when initially there are only two input and/or output signals, for example, when establishing a teleconference and there are only two participants involved. Later, when the number of input and/or output signals is increased, for example when new participants join the teleconference, the processing could be switched to be carried out in accordance with one of the disclosed embodiments.

A mixer may be hosted by a teleconference bridge, which is typically a server which is configured to a telecommunications network and the operation of which is managed by a service provider maintaining the conference call service. The conference bridge decodes the speech signal from the signals received from the terminals, combines these speech signals using a processing method according to one or more of the disclosed embodiments, encodes the processed audio signal(s) with the selected transmitting codec and transmits it back to the terminals. The conference bridge may be a dedicated conference server carrying out only teleconference-specific tasks, also several teleconferences concurrently, or the conference bridge may be a general-purpose server carrying out all kinds of tasks, but including also teleconference tasks in accordance with the embodiments. Furthermore, in some system implementations teleconference bridge functionality can be split between two or more devices. A device can be a dedicated server device or, for example, a user terminal that may (also) act as server hosting teleconference bridge functionality or part of teleconference functionality.

As described above for a mixer in the context of teleconference, similar consideration is also valid for example to a gaming server or a server hosting a virtual reality system according to an embodiment of the invention.

It should be noted that the functional elements of the audio mixing arrangement according to the invention and the parts belonging to it, such as a conference bridge or a terminal acting as a server, can be preferably implemented as software, hardware or as a combination of these two. Software comprising commands that can be read by a computer e.g. to control a digital signal processing processor DSP and perform the functional steps of the invention is particularly suitable for implementing the spatial processing according to the invention. The spatial processing can be preferably implemented as a program code, which is stored in memory means and can be performed by a computer-like device, such as a personal computer (PC) or a mobile station, to provide the spatialization functions by the device in question. Furthermore, the spatial processing functions of the invention can also be loaded into a computer-like device as program update, in which case the functions of the embodiments can be provided in prior art devices.

It is also possible to use hardware solutions or a combination of hardware and software solutions to implement the inventive means. Accordingly, the above computer program product can be at least partly implemented as a hardware solution, for example as ASIC or FPGA circuits, in a hardware module comprising connecting means for connecting the module to an electronic device, or as one or more integrated circuits IC, the hardware module or the ICs further including various means for performing said program code tasks, said means being implemented as hardware and/or software.

It is obvious that the present invention is not limited solely to the above-presented embodiments, but it can be modified within the scope of the appended claims.

1.-27. (canceled)

28. A method comprising:
receiving a plurality of audio input signals in a mixer apparatus;
selecting a predetermined number of active audio input signals to be used as a basis for room effect signal generation;
applying the predetermined number of dedicated room effect processing units based at least partly on the selected predetermined number of audio input signals;
creating a set of spatialized signals for a plurality of audio output signals; and
creating the plurality of audio output signals by combining, for each output signal m, spatialized signals created for the output signal m and room effect signals from all room effect processing units.

29. The method according to claim 28, wherein said creating the plurality of audio output signals further comprises excluding the room effect signals determined based at least partly on at least one input signal corresponding to the output m.

30. The method according to claim 28, the method further comprising:
in response to the spatialized signals created for the output signal m including a spatialized signal created for at least one input signal corresponding to the output signal m, excluding the spatialized signal created for the at least one input signal corresponding to the output signal m.

31. The method according to claim 28, the method further comprising:
creating, for each of the plurality of audio output signals, a set of spatialized signals for the output signal m by applying dedicated spatial processing to a set of audio input signals, wherein the set of audio input signals comprises all of the plurality of audio input signals.

32. The method according to claim 28, the method further comprising:
creating, for each of the plurality of audio output signals, a set of spatialized signals for the output signal m by applying dedicated spatial processing to a set of audio input signals, wherein the set of audio input signals comprises a subset of the plurality of audio input signals, said subset including the selected predetermined number of active audio input signals.

33. The method according to claim 28, the method further comprising:
creating, for each of the plurality of audio output signals, a set of spatialized signals to be shared by all audio output signals by applying common spatial processing to a set of audio input signals.

34. An apparatus for mixing audio signals for spatial audio representation, the apparatus comprising:
a plurality of inputs for receiving a plurality of audio input signals in the apparatus;
a control unit for selecting a predetermined number of active audio input signals to be used as the basis for room effect signal generation;
a plurality of dedicated room effect processing units, from which the predetermined number of dedicated room effect processing units are arranged to be applied on the selected predetermined number of audio input signals;
a plurality of spatial processing units for creating a set of spatialized signals for a plurality of audio output signals; and
one or more combining units for creating the plurality of audio output signals by combining, for each output signal m, spatialized signals created for the output signal m and room effect signals from all room effect processing units.

35. The apparatus according to claim 34, further comprising:
an output select unit for selecting, based on a control signal received from the control unit, which room effect signals are to be combined with each of the spatialized signals created for the output signal m.

36. The apparatus according to claim 35, wherein the output select unit is arranged to exclude the room effect signals determined based at least partly on at least one input signal corresponding to the output m.

37. The apparatus according to claim 35, wherein
in response to the spatialized signals created for the output signal m including a spatialized signal created for at least one input signal corresponding to the output signal m,
the output select unit is arranged to exclude the spatialized signal created for the at least one input signal corresponding to the output signal m.

38. The apparatus according to claim 34, wherein
the plurality of spatial processing units are arranged to create, for each of the plurality of audio output signals, a set of spatialized signals for the output signal m by applying dedicated spatial processing to a set of audio input signals, wherein the set of audio input signals comprises all of the plurality of audio input signals.

39. The apparatus according to claim 34, wherein
the plurality of spatial processing units are arranged to create, for each of the plurality of audio output signals, a set of spatialized signals for the output signal m by applying dedicated spatial processing to a set of audio input signals, wherein the set of audio input signals comprises a subset of the plurality of audio input signals, said subset including the selected predetermined number of active audio input signals.

40. The apparatus according to claim 34, wherein
the plurality of spatial processing units are arranged to create, for each of the plurality of audio output signals, a set of spatialized signals to be shared by all audio output signals by applying common spatial processing to a set of audio input signals.

41. The apparatus according to claim 34, wherein
the control unit is arranged to set the predetermined number of the active audio input signals to be selected as two.

42. The apparatus according to claim 34, wherein
said dedicated room effect processing units are arranged to apply room effect processing to the selected predetermined number of audio input signals.

43. The apparatus according to claim 34, wherein the apparatus is a mobile terminal arranged to operate as server for mixing audio signals for spatial audio representation.

44. The apparatus according to claim 34, wherein the apparatus is a server dedicated for mixing audio signals for spatial audio representation.

45. The apparatus according to claim 34, wherein the apparatus is a server arranged to carry out other operations in addition to mixing audio signals for spatial audio representation.

46. An apparatus arranged to carry out concurrently a plurality of processes according to the method of claim 28.

47. A computer program product, stored on a computer readable medium and executable in a data processing device, for mixing audio signals for spatial audio representation, the computer program product comprising:
a computer program code section for controlling reception of a plurality of audio input signals in the data processing device;
a computer program code section for selecting a predetermined number of active audio input signals to be used as the basis for room effect signal generation;
a computer program code section for applying the predetermined number of dedicated room effect processing units based at least partly on the selected predetermined number of audio input signals;
a computer program code section for creating a set of spatialized signals for a plurality of audio output signals; and
a computer program code section for creating the plurality of audio output signals by combining, for each output signal m, spatialized signals created for the output signal m and room effect signals from all room effect processing units.
